(19) United States
(12) Patent Application Publication
(10) Pub. No.: US 2024/0362398 A1
(43) Pub. Date: Oct. 31, 2024

(54) DOCUMENT DATA EXTRACTION AND SEARCHING

(71) Applicant: Base64.ai, Inc., New York, NY (US)

(72) Inventors: Ozan Eren Bilgen, New York, NY (US); Alperen Sahin, Istanbul (TR); Ihsan Soydemir, Munich (DE); Mustafa Batuhan Ceylan, Balikesir (TR); Gulsah Dengiz, Bursa (TR); Mizane Johnson-Bowman, Voorhees Township, NJ (US)

(21) Appl. No.: 18/433,280

(22) Filed: Feb. 5, 2024

Related U.S. Application Data
(63) Continuation-in-part of application No. 18/344,141, filed on Jun. 29, 2023.
(63) Continuation-in-part of application No. 18/342,612, filed on Jun. 27, 2023.
(63) Continuation-in-part of application No. 18/336,888, filed on Jun. 16, 2023.
(63) Continuation-in-part of application No. 18/307,682, filed on Apr. 26, 2023.

(51) Int. Cl. G06F 40/106; G06F 16/33

(52) U.S. Cl. CPC G06F 40/106; G06F 16/3344

(57) ABSTRACT

Systems and methods of the inventive subject matter are directed to the use of large language models to improve data extraction, storage, and searching. Specifically, platforms implementing embodiments of the inventive subject matter are configured to receive uploaded documents. Once received, the contents of the document can be extracted, and key-value pairs can be generated using that content by applying a taxonomy. For any text content that cannot be index using the applied taxonomy, the platform can apply OCR and then use an LLM to generate additional key-value pairs. Once key-value pairs are created and saved to a database, plan language user-generated search queries can be received. An LLM can once again be used to create database search queries, resulting in the ability to search though uploaded documents for specific content along with types of content.

This application is a continuation-in-part and claims priority to U.S. patent application Ser. No. 18/344,141, filed Jun. 29, 2023; U.S. patent application Ser. No. 18/342,612, filed Jun. 27, 2023; U.S. patent application Ser. No. 18/336,888, filed Jun. 16, 2023; and U.S. patent application Ser. No. 18/307,682, filed Apr. 26, 2023. All extrinsic materials identified in this application are incorporated by reference in their entirety.

### FIELD OF THE INVENTION

The present invention relates generally to the field of natural language processing, and more specifically, to systems and methods for extracting key-value pairs from documents using large language models and using the extracted information to facilitate improved document searching.

### BACKGROUND

The background description includes information that may be useful in understanding the present invention. It is not an admission that any of the information provided in this application is prior art or relevant to the presently claimed invention, or that any publication specifically or implicitly referenced is prior art.

The extraction of structured information from unstructured text documents is a critical task in many domains, including information retrieval, knowledge management, and business intelligence. In information retrieval, efficiently locating relevant documents within large collections requires accurate extraction of key entities and relationships. In knowledge management, building knowledge bases or ontologies often involves extracting structured data from text sources. In business intelligence, extracting key information from business documents, such as contracts, invoices, or emails, can help to automate tasks and provide valuable insights. In all these contexts, by extracting structured information from an unstructured document facilitates granular searching that is not otherwise available when conducting ordinary text searches through unstructured documents.

Traditional approaches to information extraction often rely on hand-crafted rules or pattern matching techniques. These methods can be effective for specific domains and document types, but they are often labor-intensive to develop and maintain, and they may not generalize well to new or evolving document structures.

Machine learning-based techniques have emerged as a more adaptable approach, but they typically require large amounts of labeled training data, which can be expensive and time-consuming to create. Additionally, the performance of these models can be sensitive to variations in language, document structure, and domain-specific terminology.

Recent advances in large language models (LLMs) have opened up new possibilities for information extraction. LLMs are trained on massive amounts of text data, enabling them to learn complex language patterns and generate human-quality text. This capability makes them well-suited for extracting information from diverse document types, even in the absence of extensive training data specific to a particular domain.

But there remains a need for improved methods for leveraging LLMs for information extraction by efficiently extracting key-value pairs from documents without requiring extensive manual annotation or rule-based systems. Moreover, once structured information has been extracted, LLMs can be used to improve search capabilities by allowing users to provide plain language search queries that an LLM can convert into a structured search query (e.g., a JSON).

### SUMMARY OF THE INVENTION

The present invention provides apparatuses, systems, and methods directed to document data extraction to facilitate searching. In one aspect of the inventive subject matter, a method of extracting searchable content from an uploaded document is contemplated, the method comprises the steps of: extracting document content from the uploaded document, the document content comprising field labels having associated field content; indexing the document content according to a taxonomy (e.g., user-defined or built-in) to create key-value pairs, where the taxonomy comprises a set of known keys that field labels can be mapped to, and where each key-value pair comprises a field label matched to a key and field content matched to a value; conducting OCR on the uploaded document to extract text content; transforming, using a large language model (LLM), the text content to create LLM generated key-value pairs; and storing the key-value pairs and the LLM generated key-value pairs to a database.

In some embodiments, the method also includes the steps of: receiving a plain language search query; passing the plain language search query to the LLM to create a database search query; receiving, from the LLM, the database search query that is based on the plain language search query; and conducting a search of the database using the database search query.

In some embodiments, the database search query can be edited by a user before it is used to conduct the search. The plain language search query can be edited by a user before it is used to create a database search query.

In another aspect of the inventive subject matter, a method of extracting, storing, and searching digital content, the method comprises the steps of: extracting document content from an uploaded document, the document content comprising field labels having associated field content and additional text content; indexing the field labels and associated field content according to a taxonomy (e.g., a user-defined or a built-in taxonomy) to create key-value pairs, where the taxonomy comprises a set of defined keys that the field labels can be mapped to, and where each key-value pair comprises a field label matched to a key and field content matched to a value; conducting OCR to extract the additional text content; transforming, using a large language model (LLM), the additional text content to create LLM generated key-value pairs; storing the key-value pairs and the LLM generated key-value pairs to a database; receiving a plain language search query; passing the plain language search query to the LLM to create a database search query; receiving, from the LLM, the database search query that is based on the plain language search query; and conducting a search of the database using the database search query.

In some embodiments, the database search query can be edited by a user before it is used to conduct the search. The plain language search query can be edited by a user before it is used to create a database search query. In some embodiments, the database search query comprises at least one key from the taxonomy.

One should appreciate that the disclosed subject matter provides many advantageous technical effects including more robust searching based on a wider variety of text and non-text based search queries.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows is an example of content that can be extracted from a driver's license.

FIG. 2 shows how taxonomies can be selected for known and unknown document types.

FIG. 3 shows how a taxonomy can be applied to different document create key-value pairs.

FIG. 4 is a flowchart describing how content is extracted from a document and stored to a database along with how searches can be generated to search the database.

FIG. 5 shows how a user-generated plain language search query can be converted into a database search query.

FIG. 6 shows an example user interface for entering user search queries.

FIG. 7 shows an example user interface for modifying user search queries.

FIG. 8 shows an example of how search results can be organized.

FIG. 9 shows an example of an interface that a user can be presented with after selecting a result from a list of search results.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Systems and methods of the inventive subject matter feature software that operates on multiple computing devices. In general, a user on a user device can interact with a platform server that is configured to run software that configures the platform server to bring about all the functions described below in relation to the platform server, the service, and so on. A user device can be any kind of computing device including phones, tablets, computers, or any other computing device capable of network communication. A user device must be able to, e.g., access a web browser or run software that is configured to connect the user to the platform server. The platform server can be, e.g., one or more servers, such as a cloud platform, that is configured to run server-side software that is configured to carry out all platform server functions and steps described in this application. Thus, systems and methods of the inventive subject matter involve communications between user devices and a platform server.

Systems and methods of the inventive subject matter are directed to indexing document content and then facilitating searches for that document content that the platform server has stored to a database. Documents of a variety of different types and having a variety of content can be scanned, classified, and searched. The process of scanning, as used in this application, refers to steps associated with creating a digital version of a document and then bringing a document into a system of the inventive subject matter. This can include physically scanning (e.g., using a scanner or taking a photo) or creating digitally stored documents (e.g., text documents, PDFs and so on), and then uploading a document of any format (e.g., PDF) to the system, classifying the document to determine its type, conducting OCR on the document to identify text content, extracting content from the document's fields, and so on. Once a document has been scanned and classified, a taxonomy can be applied to, e.g., create key-value pairs from content extracted from the document. Key-value pairs are then stored, by the platform server, to a database to facilitate searching.

The process of searching can take place after document content and information has been stored to the database (e.g., key-value pairs, text content, document properties, and so on). Searching makes use of one or more large language models (LLMs) to facilitate generating search queries to search through document information stored in a database of the inventive subject matter. By implementing an LLM, a search can be input using natural language, and the fields and information a user is searching for can be extracted from the natural language query to be used in a database search (e.g., a JSON search).

Thus, systems and methods of the inventive subject matter can be described in two stages: document importing and document searching. Document importing includes the step of document classification, which is described in detail in U.S. patent application Ser. No. 18/307,682, entitled, “Multi-Modal Document Type Classification Systems and Methods”; Ser. No. 18/342,612, entitled, “Visual Segmentation of Documents Contained in Files”; and Ser. No. 18/344,141, entitled, “Multi-Modal Document Type Classification Systems and Methods.” This application claims priority to all these applications, and they are included by reference in their entirety, here.

The first step in document classification is identifying a document type. Document types can include, e.g., documents like insurance forms, tax forms, invoices, receipts, and so on. To identify a document type, a user must first upload a document to a platform server of the inventive subject matter. Once uploaded, the platform server carries out steps to classify the uploaded document. In some embodiments, one or more documents can be uploaded in a single file, as described in application Ser. No. 18/342,612.

Document classification, as described in, e.g., application Ser. No. 18/307,682, is thus carried out by the platform server in coordination with a user device (which is responsible for uploading a document to the platform server). In document classification, information such as document type and document content is extracted from the document through a combination of artificial intelligence, OCR, and so on.

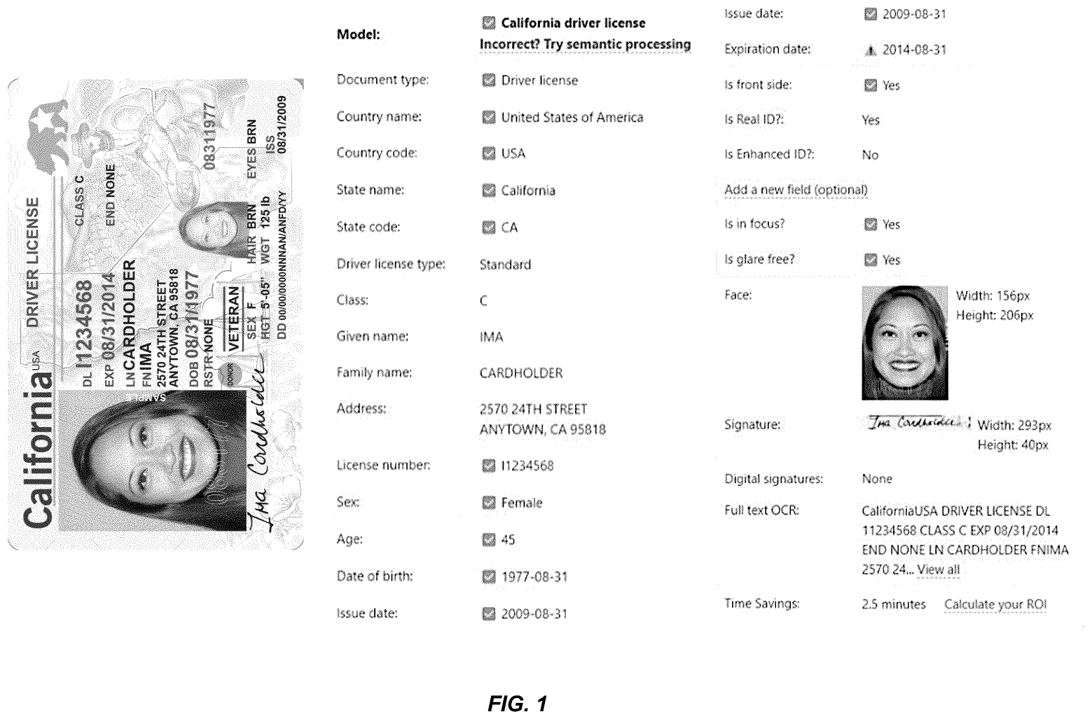

The result of document classification is that the platform server has extracted information and can generate an output comprising all or some of the extracted information. FIG. 1 shows an example of a California driver's license next to an output that the platform server can generate, where the output contains information extracted from the driver's license. After a document has been classified and all information from the document has been extracted, the platform server can then apply a taxonomy to the extracted information to make its contents searchable.

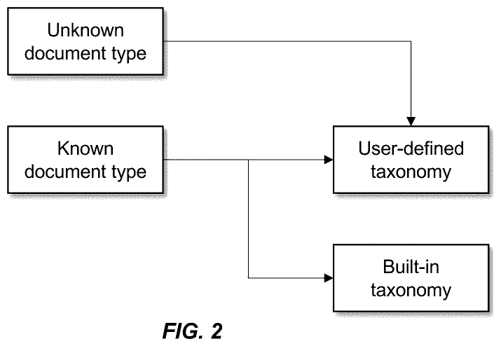

Embodiments can use built-in taxonomies, user-created taxonomies, or, in some cases, no taxonomy at all. A taxonomy, in the context of the inventive subject matter, is a system of consistent classification that can be used to catalog information from a document. A taxonomy can be applied according to whether a document type is known or unknown. FIG. 2 is a flowchart directed to how a platform server can determine what type of taxonomy can be used. If the document type is known, then the system can use either a built-in taxonomy or a user-defined taxonomy, and if the document type is unknown, then the system can use a user-defined taxonomy. Although not shown, it should be understood that, in some cases, no taxonomy is used at all. A taxonomy of the inventive subject matter includes a set of known terms, or “keys” that can be assigned “values” (e.g., key-value pairs). Field labels from a document can be mapped onto keys in a taxonomy and field content from the document can be associated with values that go to those keys, creating key-value pairs.

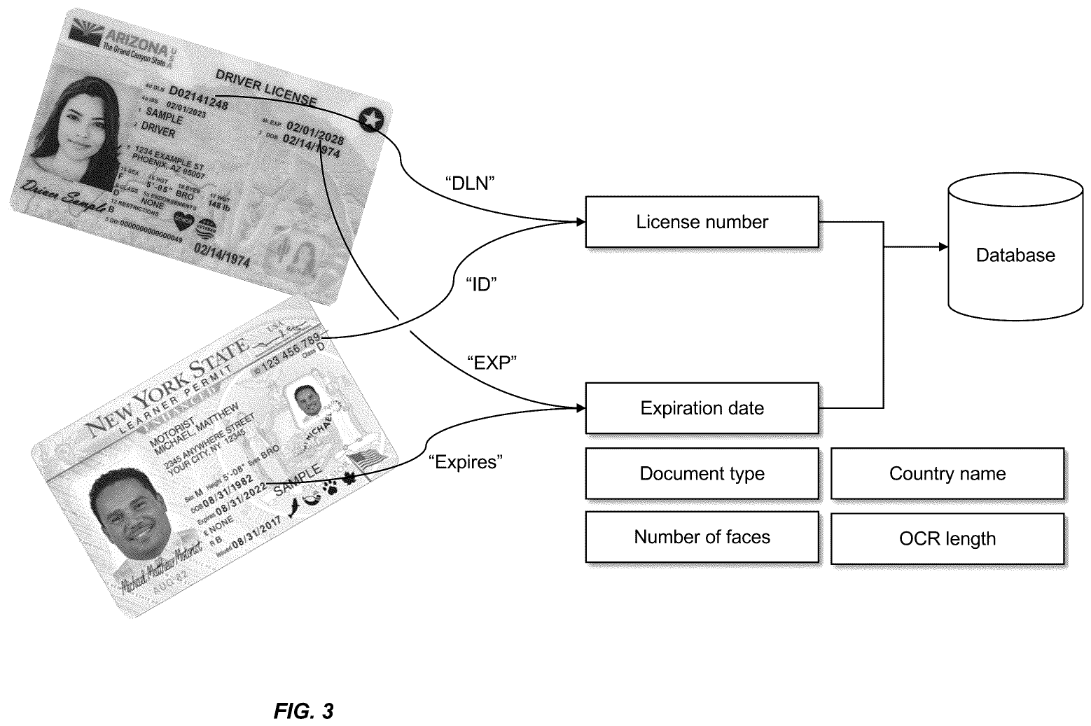

FIG. 3 shows an example of how a built-in taxonomy can be applied to two different driver's licenses-both of which are known documents. In this case, the document type is known-both documents are driver's licenses. For driver's licenses, a built-in taxonomy is then applied. For example, the taxonomy can include “license number” that can be used for field labels that relate to driver′ license numbers. In the example in FIG. 3, there are two different field labels for driver's license number: “DLN” and “ID.” By applying the taxonomy, both the “DLN” and “ID” field labels are assigned to the “license number” key. Once a field label is associated with a key, its associated field content can be associated with a value that is paired with that key. For the Arizona driver's license, that means that the “license number” key will be associated with the value, “402141248,” and for the New York learner's permit, the “license number” key will be associated with the value, “123 456 789.” Each different key-value pair can be associated with a specific document, making it possible, for example, for many different key-value pairs to exist using the same key and to make those different key-value pairs using the same key to be searchable according to which document they belong to.

In addition to assigning values to a “license number” key, FIG. 3 also shows that values are assigned to an “expiration date” key. Again, expiration date field labels differ between the two licenses. The New York learner's permit uses the field label “Expires” and the Arizona driver's license uses the field label “EXP.” The built-in taxonomy that is used thus allows the platform server to map both field labels onto the “expiration date” key, assigning values to that key according to the field content associated with each field label. Each key-value pair is additionally associated with the document from which the key-value pair was created.

Thus, a taxonomy is used to create key-value pairs from content in a document by mapping field labels to keys and mapping field content to values associated with each key. As shown in FIG. 3, more information about a document can also be made searchable, including, e.g., document type, country name, number of faces, OCR length, and so on. Accordingly, in the process of classifying a document, extracting data, and creating key-value pairs by applying a taxonomy, metadata about the document can also be made searchable.

FIG. 3 goes through an example of a built-in taxonomy being applied to known documents, but as FIG. 2 asserts, user-defined taxonomies can also be used in some circumstances. For example, user-defined taxonomies can be used for known document types. When a known document is uploaded, but no built-in taxonomy exists, a user-defined taxonomy can be used instead (when such a taxonomy exists). Once a user-defined taxonomy is identified, key-value pairs can be created using content from the document. User-defined taxonomies can be identified by, e.g., matching a number of field labels in a document to a number of keys in a taxonomy. If the number matches, it is likely that taxonomy applies, and the platform server uses that taxonomy. Large language models can also be used to determine whether field labels can be appropriately mapped onto keys in a user-defined taxonomy. If all field labels can be matched to keys in a user-defined taxonomy using an LLM to assist with linguistic matching, then it is likely that taxonomy applies, and the platform server uses that taxonomy for the unknown document.

User-defined taxonomies can be identified for use in a variety of other ways, as well, including: by a user adding fields via post-processing integrations (e.g., by writing low-code), via question and answers (e.g., by asking a user several questions about a document, the platform server can determine whether to use a specific user-defined taxonomy), and manually via website where a user selects a user-defined taxonomy that should be applied. Once a user-defined taxonomy is identified, it can then be applied to one or more documents.

In some cases, no taxonomy exists. In such cases, an end user can be prompted to create a new user-defined taxonomy, though this step is not necessary. To create a user-defined taxonomy, a user can be prompted to write a key for each field label. The user would provide this information on a user device and then send it to the platform server via network connection. Each user-defined key can then be used to create a key-value pair using field content from the document.

In some instances, a user may not create a new taxonomy, and thus no taxonomy is used at all. The platform server would thus extract information without using a taxonomy. This can occur, for example, in a document that has primarily visual content or coded content (e.g., a bar code of some type) instead of textual information, though this can also be the case for primarily text-based documents, as well. If no taxonomy is used and the document is text-based, an LLM can be used to extract information from the document without the use of key-value pairs.

As mentioned above, once the platform server identifies a taxonomy that can be used with a document, the platform server conducts indexing. The step of indexing involves matching field labels to keys and assigning field content to values that match with those keys. Indexing thus creates key-value pairs that can be used to facilitate searches through the indexed document.

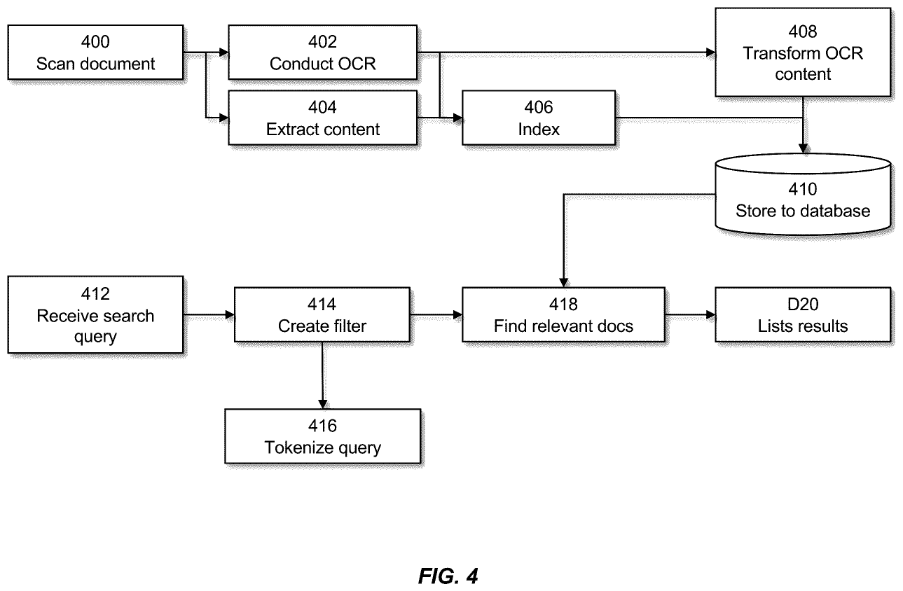

FIG. 4 describes this process. In step 400 document scanning takes place. Document scanning, described above, is the process in which a document is scanned and then uploaded to the platform server (e.g., as an image file, a PDF, or the like). During step 400, a document is scanned into a digital format and uploaded to the platform server. If the document already exists in a digital format, the step of scanning into a digital format may be unnecessary and the document can simply be uploaded in its original digital format. Once received by the platform server, the platform server conducts OCR (optical character recognition) per step 402 and works to extract information contained in the fields of the document per step 404. Once both steps 402 and 404 are completed, the platform server can carry out indexing in step 406, where key-value pairs are created using field labels and field content found in the document. This process is described above in more detail. Steps 400, 402, and 404 together make up the process of classifying a document, which is described in detail in, e.g., U.S. patent Ser. No. 18/307,682.

As indicated in FIG. 4, after conducting OCR in step 402, the platform server can move to one or both of steps 406 and 408. As discussed above, step 406 is where content in fields of a document is matched to keys from a taxonomy. Multiple keys are shown (document type, number of faces, OCR length, country name, expiration date, and license number) to demonstrate that only relevant keys are used (license number and expiration date). But in cases where no taxonomy is used at all, information pulled via OCR is passed to step 408 where it is subject to transformation. Transformation is a process by which unknown fields can be transformed via LLM into usable information.

LLMs are configured to understand language variations. Thus, when an LLM is applied to an unknown field, it can automatically create key-value pairs from the content of a document. For example, if a document says “San Francisco” and the prompt for that response is “City” in an address field, an LLM can automatically match those two without applying any taxonomy or translation. By doing so, the LLM transforms content from words on a page into key-value pairs.

Embodiments of the inventive subject matter make searching more effective. For example, users are enabled to search by field. In the past, when searching through a digital document, a user's searches were limited by text input. A user could search for specific terms or words. For example, a user could search for places where the word “address” appears in a document. But by implementing systems and methods described in this application, users can conduct searches according to normalized values for content contained within a document.

Searching documents by field is thus possible. In one example, if a user searches for a due date on an invoice in a PDF, the user would have previously had no way to search for that due date without already knowing the right key word or words that might appear near the due date. Embodiments of the inventive subject matter make it possible for a user to search for a “due date” field to find the document's due date. Moreover, users can also look for field content using different operators. For example, if a user wants to find documents having a due date that are greater than some date, then when entering a search, the user can specify that they are searching for the due date field and that they need the due date to be greater than or equal to a specified due date.

In a more specific example, if a company has received hundreds of driver's license uploads, and that company needs to know which of those driver's licenses has expired, the company could conduct a search based on driver's license expiration dates. The search would look only at the “expiration date” field and then look for only those licenses whose expiration date is greater than the current date.

After carrying out step 406 and 408, key-value pairs that result are stored to a database in step 410. Similarly, after transforming is carried out in step 408, information is stored to the database in step 410. A database used in embodiments of the inventive subject matter is searchable via network connection. For example, an Elastic Database can be searched by a search engine called Elasticsearch, which is a distributed, multitenant-capable full-text search engine with an HTTP web interface and schema-free JSON documents. Elastic Database is an example of a database that can be used—other types, formats, or configurations can be used as well and alternatively. All information stored to the database can thus be subject to end user search.

FIG. 4 also shows steps relating to receiving user queries and using those queries to generate a database search operation. Because information is now stored to the database in step 410, that information must be retrievable, and systems and methods of the inventive subject matter facilitate such searches. In step 412, a user provides a search query. The search query can be received in any format and by any means the user desires. For example, in some embodiments, a user can provide a plain language search, while in other situations, a user may submit search terms as a list of keywords that the user would like to retrieve from the database.

In an example of a plain language search, for example, a user can use text-to-speech software to speak out a search query. Text-to-speech software converts the spoken language into text. Once written into text, the user can edit the query before submitting it to the platform server. If, for example, the text-to-speech software makes an error, or the user decides to make changes to the search for any other reason, the user can do so at this time.

After creating a search query, a user can then submit the search query to the system. Upon receiving the search query, the platform server creates a filter according to step 414. The filter converts the search query into a set of one or more database search terms (e.g., a JSON) through a process called tokenization, shown as step 416. The purpose of creating a tokenized filter is to generate a search query that is designed to retrieve information from the database where document information has been stored according to the steps described above.

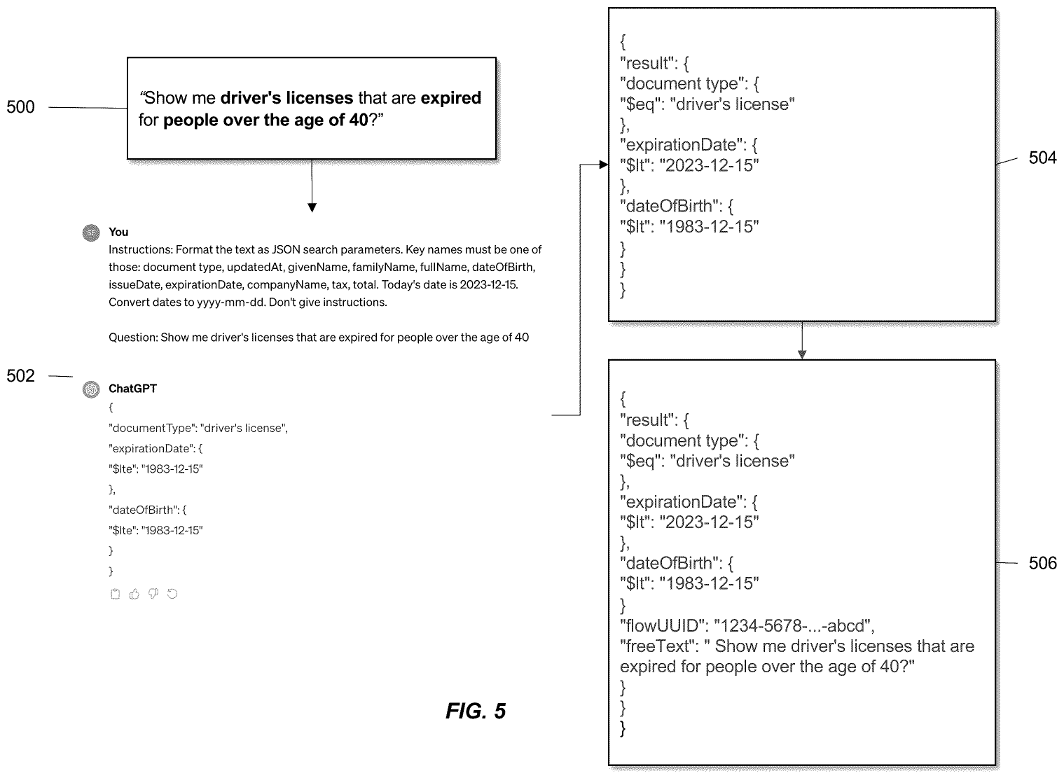

An example of the tokenization process is shown in FIG. 5. Upon receiving a search query from a user, the platform server is configured to use an LLM to further process the search query. Block 500 shows the example search query, “Show me driver's licenses that are expired for people over the age of 40?” This query, in the figure, has been formatted to emphasize pertinent portions of the query, and therefore appears as, “Show me driver's licenses that are expired for people over the age of 40?” The words “driver's license” are directed to a property of the document itself—i.e., is it a driver's license? The words “expired” and “people over the age of 40” are directed to contents of the document—i.e., is the license expired and is the birthdate on the license more than 40 years ago from today's date?

Thus, the user's plain language search query is processed by an LLM, and the LLM determines what the operative aspects of the query are. For example, the LLM would interpret the language of the user's query to identify that the user is searching for driver's licenses, that the driver's licenses must be expired, and that the driver's licenses must belong to people over the age of 40.

Block 502 shows how an LLM (e.g., ChatGPT or LLama2) can be further used to create search queries that are usable by the database (i.e., whatever database the platform server is configured to communicate with to store and retrieve document information to and from). The platform server uses the user's search query to develop a request for the LLM. The request includes instructions for the LLM to create a JSON that can be used by the platform server to conduct a database search. In this example, the instructions states:
“Instructions: Format the text as JSON search parameters. Key names must be one of those: document type, updatedAt, givenName, familyName, fullName, dateOfBirth, issueDate, expiration Date, companyName, tax, total. Today's date is 2023 Dec. 15. Convert dates to yyyy-mm-dd. Don't give instructions.
Question: Show me driver's licenses that are expired for people over the age of 40”

Thus, according to block 502, an LLM is used to generate a database search query (e.g., a JSON search query). A JSON is an open standard file format and data interchange format that uses human-readable text to store and transmit data objects consisting of key-value pairs and arrays. At any point during block 500 and 502, the search can be subject to user modification. For example, a user may input a plain language search (or any other type of search) and then be allowed to make changes to that search before the platform server sends that search out to an LLM for conversion into a JSON search query. In another example, once the JSON search query is generated by the LLM, the search can be subject to user modification. Thus, the platform server would use the LLM to generate a JSON search query, send that search back to the user for modification, and then receive a modified search from the user that it can then use to search the database.

Block 504 thus shows a JSON search query created using the instructions shown above and that is accessible to a user. The instruction, “document type”: {“$eq”: “driver's license”} causes a search for documents that have an “document type” key having a value that “driver's license” (i.e., find driver′). The instruction, “expiration Date”: {“$lt”: “2023 Dec. 15”} requires that the search result only include those documents that have a value for the key “expiration date” that is less than 2023 Dec. 15 (i.e., driver's licenses that expired before that date, which would be the current date in such query). Finally, the instruction “dateOfBirth”: {“$It”: “1983 Dec. 15”} restricts search results to driver's licenses where the “date of birth” key has a value is that is less than 1983 Dec. 15 (i.e., the person is older than the age of 40 as of the date the query was created-in this case 1983 Dec. 15).

The search shown in block 504 features fewer search terms than are shown in block 506, because block 506 shows a JSON search query that the platform server would have access to (as opposed to block 504, which shows a JSON search query that a user would have access to). Thus, block 506 includes, for example, a restriction that requires a “flowUUID,” and it includes the specific user's flowUUID. The instruction “flowUUID”: “1234-5678 . . . abcd” requires that the platform server search only for those documents associated with that flowUUID. Thus, the key is flowUUID and the value paired with that key is “1234-5678 . . . abcd.” This portion of the JSON search query cannot be shown to end users because it would allow end users to modify the flowUUID to potentially gain access to documents and information in the database that does not belong to them. Allowing users to change only certain aspect of a JSON search query can therefore be a matter of document security.

Thus, by adding a flowUUID into the JSON search query, a search can be restricted to only those documents that a specific user has access to (e.g., documents that a specific user uploaded to the platform server and are associated with that user's account). The search shown in block 506 additionally includes the plain text of the search used to generate the JSON search query. This is presented as another key-value pair: “freeText”: “Show me driver's licenses that are expired for people over the age of 40?” Because some information cannot be categorized as key-value pairs (e.g., the terms of an NDA or another document that is primarily written in long form), including the full text can facilitate searching a database using a text search. This can be especially useful in unstructured documents.

Thus, searches can be subject to various restrictions and filters, including access control, query control, and various granular search filters. A search that is subject to access control means that the search can only look through certain documents stored in a database. This is demonstrated in the discussion above by including a flowUUID search term, which can indicate document ownership. Access control restricts searches to only those documents a specific user has access privileges to. Access control can be restricted on the server side, which prevents situations where a user can select whether they want to be able to access another user's documents. This is shown in block 506, which shows a platform server-side JSON search query that a user does not have access to, which features a flowUUID filter to restrict search access.

When a search is subject to query control, that means the search can be modified by a user or by the platform server to ensure the search comports with the user's intent. When the user is able to carry out query control, that means the user is able to modify the terms of a search at one or more points throughout the process of developing a JSON search query. For example, a user may modify a search when the user first inputs a plain language search query that can be used to generate a JSON search query. At this stage, a user may, e.g., correct typos, misspellings, or add or subtract search terms that they initially created.

Users can also exercise query control on a JSON search query. After a platform server receives a user's plain language search and uses an LLM to generate a JSON search query, the JSON search query can be manually modified by a user to ensure the search is conducted according to the user's true intent, which can only be known to the user (e.g., if a user forgot a search term, they will know that and be able to modify the JSON search query accordingly). JSON search queries can be modified directly or indirectly. Direct modification entails a user directly changing the contents of a JSON search. For example, a user may add or delete key-value pairs that are included in a JSON search. In some embodiments, a user can be presented with a user interface to facilitate making changes to a JSON search query. JSON search query terms can be used to create a user interface because JSON search queries include search terms presented as, e.g., key-value pairs. Keys and associated values can be shown in a user interface, allowing users to modify values for various keys while also allowing users to add new keys with associated values (or, in some embodiments, keys having no associated values to find any content associated with the key).

When a platform server carries out query control, the platform server may act similarly to a user conducting query control. For example, the platform server may correct typos, fix spelling errors, or add or remove filters. A filter may be added if, e.g., a user attempts to specify a search filter that does not make sense considering the searchable database For example, if a user does not specify a date range for documents in a search, but returning every document for every possible date would result in returning thousands of documents, the platform server may add a date range to the search. In doing so, the platform server can alert the user to the addition of the date range, giving the user an option to audit the addition. The platform server can similarly remove a filter that does not make sense. For example, if a user specifies that they only want to search for insurance contracts that were born before a specified date, the platform server may remove that filter because documents should not have birth dates. In some cases, the platform server can replace an inappropriate filter with one that makes more sense-such as replacing date of birth with date of creation.

Embodiments of the inventive subject matter can also be configured to carry out granular searches. Granular searches are those searches that include specific details about a document, such as document type, document fields, document features, file format, and so on. Document type can be used in a search because, for example, hierarchical document type classifications allow the platform server to select one or more models. For example, if a user searches for a New York driver's license, the platform server can return multiple documents (e.g., multiple New York driver's licenses) that fit that classification. The same would be true for other searches, such as searches for California driver license's, U.S. driver's licenses, ID documents, and so on.

Fields can be used as search terms, as well. Because field names are normalized (e.g., according to the indexing process described above), field names can be used to search across multiple documents with different taxonomies. This is because, in some cases, multiple taxonomies use the same field labels (which are normalized into keys for key-value pairs) to classify content in different documents. For example, multiple different taxonomies may include the field labels “first name” and “last name.” Although different taxonomies apply to different documents, the field labels “first name” and “last name” nevertheless map to the same keys for first name and last name. Thus, a search that is intended to find field content associated with a specific field label that has been normalized to a key can search across multiple documents due to the normalization of field labels to the same key that is used across multiple taxonomies. Thus, searches can be conducted on the basis or one or more common fields (e.g., fields relevant to a specific document, such as “Expiration Date”).

Searches can also be conducted on the basis of one or more predefined fields (e.g., fields that are generic across multiple documents). Predefined fields can include: “file name”; “updated at”; “created at”; “status”; “integration status”; “model name”; “model type”; “number of faces”; “number of signatures”; “number of tables”; “number of tables”; “page count”; “mime type”; “is in focus”; “is glare free”; “is selectable”; and “is editable.”

Document features can also be used in searches. For example, a search filter may require a search to filter documents according to non-text properties such as contracts that remain unsigned. During document classification, the process of classifying the document and extracting information from the document may reveal that a document having a space for a signature does not have any content in that signature space. In that case, the classification process may store for that client a key-value pair to the effect of “numberOfSignatures=0” to indicate that the document is not signed. In doing so, this feature of the document (and others) can be subject to search. Other non-text features can be subject to search in the same way, such as number of pages, number of words, number of fields, whether a document includes a photograph, and so on. Thus, a search based on a feature of a document (e.g., a non-text, non-OCR search) can be a search for documents that have a glare on them or simply the file name (e.g., text content that does not appear on the document itself).

Searches can also account for file format. When classifying a document, the format of the file that the document is uploaded as can be included in its classification (even though document format may be changed in classifying the document). By storing information about what format a user originally uploaded a document as, users can search for documents that were uploaded in specific formats, such as JPEG, *.docx, PDF, image files (i.e., images generally as opposed to specific image formats), and so on. Information about document format can be stored as, e.g., a MIME type attribute. MIME types are defined by three attributes: language (lang), encoding (enc), and content-type (type). Any file format can be classified. In doing so, users can search for documents according to format—for example a user may want to find all documents originally uploaded as image files, and the platform server could then generate a JSON search query to that effect that returns to the user a list of all documents that were originally uploaded as image files.

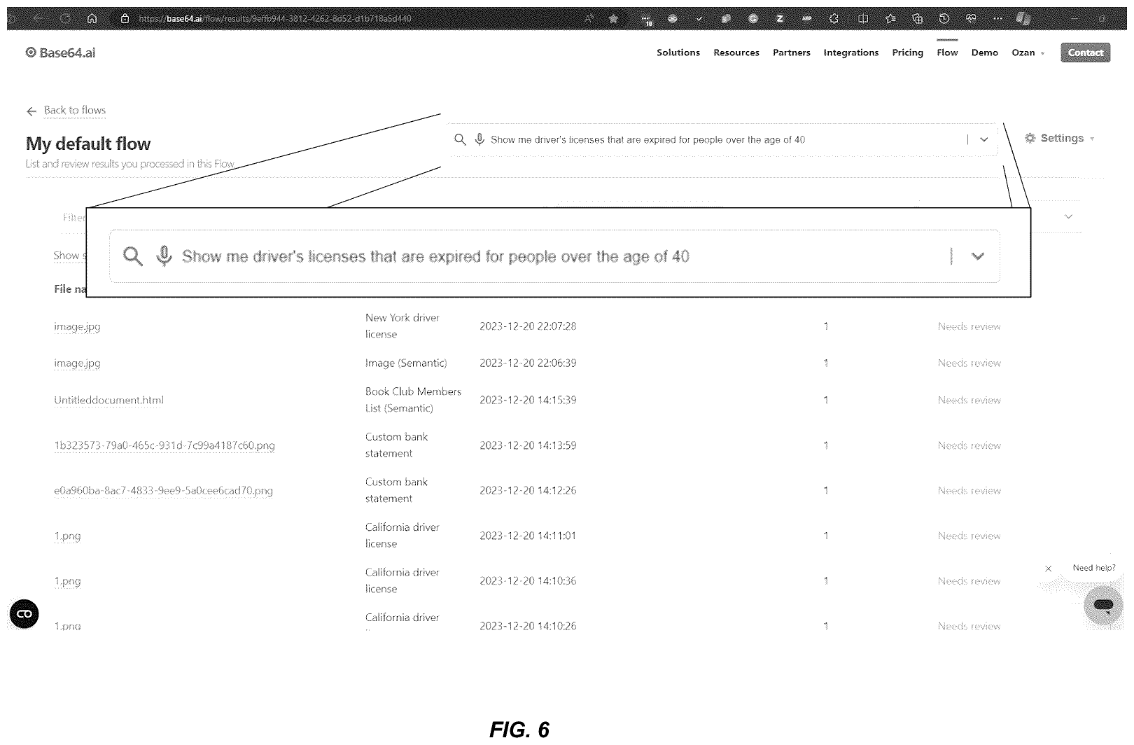

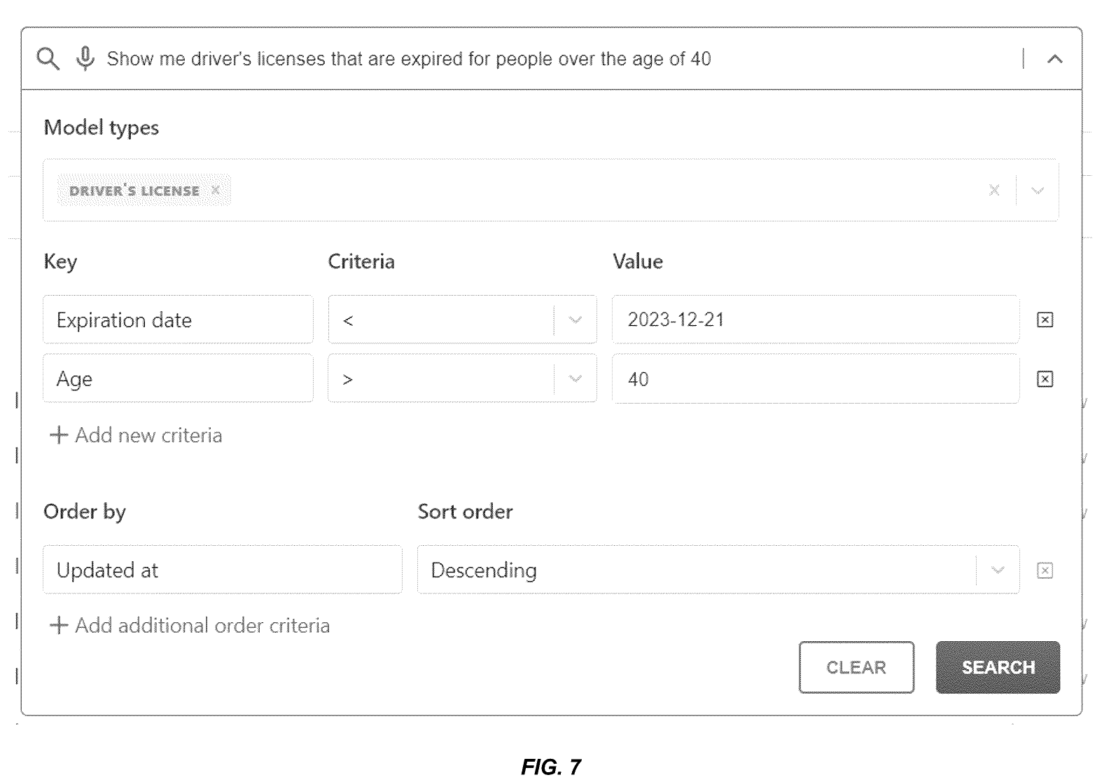

FIGS. 6-9 show an example of how a plain language search can be modified via user interface in the process of conducting a search. In FIG. 6, a plain language search is input into a text box that is configured to receive user searches. Once the plain language search is input into the text box, the steps described above are carried out—the platform server uses an LLM to develop a JSON search query—and once the JSON search query is created, the user interface can use elements of the JSON search query to allow the user to edit different elements of the search. FIG. 7 thus shows a resulting user interface that has taken elements of the JSON search query generated using the plain language search query from the user and put those elements in easy-to-use user interface elements. Here, a first section is generated for “model type,” a second section is generated for one or more key-value pairs that are used in the search, and a third section is generated to allow a user to select how results are displayed. Here, the “model type” is “driver's license,” the keys in use are “Expiration date” and “Age,” and the results are set to be organized in descending order. The values for each key are shown and made editable—the user has specified that the expiration date should be less than 2023 Dec. 21 (i.e., less than the current date, meaning the driver's licenses in the search results should be expired) and that the age of the person the license belongs to is over 40.

With this user interface, a user can edit search terms. For example, the user can change the date, change the operator describing the relationship between a key and its associated value (e.g., change a “>” to a “<”), or even change the key-value pair that is used in the search entirely (e.g., by adding a new key-value pair to the search, by taking away existing key-value pairs, or both). Thus, through this interface, users can add new search terms or filters. When a user adds new search terms or filters using the user interface, those search terms can be added to a JSON search query by the platform server.

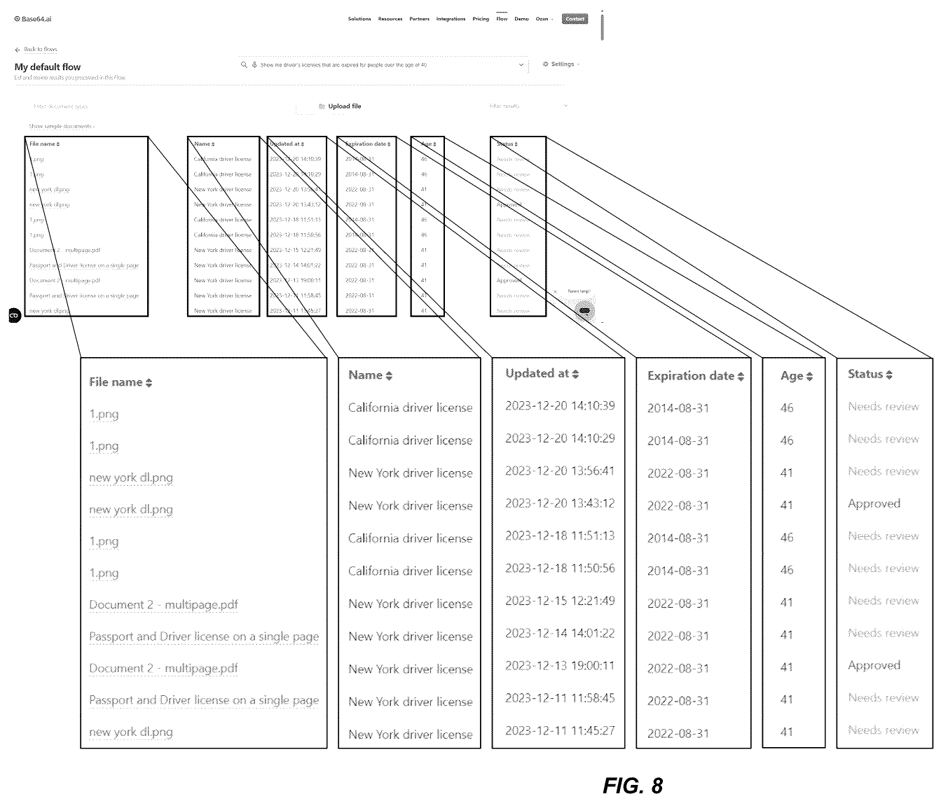

FIG. 8 shows how search results can be organized. The first column shows the filename of each document. Document filename alone may not provide much information, and so the next column shows the name of each document according to its classification. The document retrieved include both New York and California driver's licenses. The next column shows a date each document was last updated (e.g., the upload date), followed by a column for expiration dates. The next column shows age (e.g., of the person each driver's license belongs to). A final column indicates a status for each individual result, which can indicate, e.g., whether a document has been “approved” or “needs review.” When a document has been “approved” that can mean, for example, that its classification has been audited by a human to ensure its accuracy.

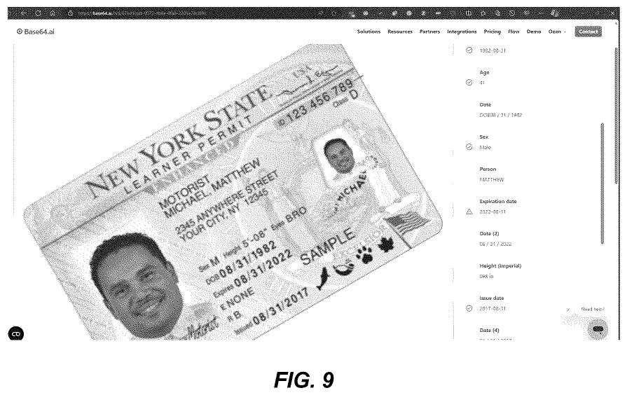

The results interface can be customized, and the columns shown in FIG. 8 are not the only columns that can be shown. Users can add, remove, or modify the columns depending on what information they would like visible in the search results interface. From this interface, a user can select a search result to get more information. FIG. 9 shows an example of an interface that a user can be presented with after selecting a result from the list shown in FIG. 8. Because the initial search query was related to driver's licenses, the selected search result comprises a New York driver's license. The right side of the interface includes information extracted from the driver's license, presented as, e.g., key-value pairs.

Thus, specific systems and methods directed to document classification, information extraction, and document searching have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of extracting searchable content from an uploaded document, the method comprising the steps of:
extracting document content from the uploaded document, the document content comprising field labels having associated field content;
indexing the document content according to a taxonomy to create key-value pairs;
wherein the taxonomy comprises a set of known keys that field labels can be mapped to;
wherein each key-value pair comprises a field label matched to a key and field content matched to a value;
conducting OCR on the uploaded document to extract text content;
transforming, using a large language model (LLM), the text content to create LLM generated key-value pairs; and
storing the key-value pairs and the LLM generated key-value pairs to a database.

2. The method of claim 1, wherein the taxonomy is user-defined.

3. The method of claim 1, wherein the taxonomy is built-in.

4. The method of claim 1, further comprising the steps of:
receiving a plain language search query;
passing the plain language search query to the LLM to create a database search query;
receiving, from the LLM, the database search query that is based on the plain language search query; and
conducting a search of the database using the database search query.

5. The method of claim 4, wherein the database search query is subject editing by a user before it is used to conduct the search.

6. The method of claim 4, wherein the plain language search query is subject to editing by a user before it is used to create a database search query.

7. A method of extracting, storing, and searching digital content, the method comprising the steps of:
extracting document content from an uploaded document, the document content comprising field labels having associated field content and additional text content;
indexing the field labels and associated field content according to a taxonomy to create key-value pairs;
wherein the taxonomy comprises a set of defined keys that the field labels can be mapped to;
wherein each key-value pair comprises a field label matched to a key and field content matched to a value;
conducting OCR to extract the additional text content;
transforming, using a large language model (LLM), the additional text content to create LLM generated key-value pairs;
storing the key-value pairs and the LLM generated key-value pairs to a database;
receiving a plain language search query;
passing the plain language search query to the LLM to create a database search query;
receiving, from the LLM, the database search query that is based on the plain language search query; and
conducting a search of the database using the database search query.

8. The method of claim 7, wherein the taxonomy is user-defined.

9. The method of claim 7, wherein the taxonomy is built-in.

10. The method of claim 7, wherein the database search query is subject to editing by a user before it is used to conduct the search.

11. The method of claim 7, wherein the plain language search query subject to editing by a user before it is used to create a database search query.

12. The method of claim 7, wherein the database search query comprises at least one key from the taxonomy.
